(19) United States
(12) Patent Application Publication
(10) Pub. No.: US 2014/0092072 A1
(43) Pub. Date: Apr. 3, 2014

(54) BISTABLE LIQUID CRYSTAL DISPLAY

(71) Applicant: CHUNGHWA PICTURE TUBES, LTD., Taoyuan (TW)

(72) Inventors: Shu-Chuan Huang, New Taipei City (TW); Cheng-Hao Hu, Taichung City (TW); Chin-I Chiang, Taipei City (TW)

(73) Assignee: CHUNGHWA PICTURE TUBES, LTD., Taoyuan (TW)

(21) Appl. No.: 13/716,214

(22) Filed: Dec. 17, 2012

(30) Foreign Application Priority Data
Oct. 1, 2012 (TW) 101136243

(51) Int. Cl. G09G 3/20

(52) U.S. Cl. CPC G09G 3/20
USPC 345/211; 345/87

(57) ABSTRACT

A bistable liquid crystal display (LCD) including a display panel, a plurality of column data drivers, and a plurality of row data drivers is provided. Each column data diver receives a plurality of phase control signals, a first high driving voltage, a first low driving voltage, and a display data, selects one of the phase control signals according to the display data, and alternately outputs the first high driving voltage and the first low driving voltage according to the selected phase control signal to form a column driving signal for the display panel. Each row data diver receives one of the phase control signals, a second high driving voltage, and a second low driving voltage and alternately outputs the second high driving voltage and the second low driving voltage according to the received phase control signal to form a row driving signal for the display panel.

### CROSS-REFERENCE TO RELATED APPLICATION

This application claims the priority benefit of Taiwan application serial no. 101136243, filed on Oct. 1, 2012. The entirety of the above-mentioned patent application is hereby incorporated by reference herein and made a part of this specification.

### BACKGROUND OF THE INVENTION

1. Field of the Invention

The invention generally relates to a display, and more particularly, to a bistable liquid crystal display (LCD).

2. Description of Related Art

In recent years, LCD has become the mainstream product in the display market thanks to its many advantages, such as high image quality, high space efficiency, and low power consumption. Among different types of LCDs, bistable LCD (for example, cholesteric LCD (CLCD)) is a new display technique offering high luminance, high contrast, low power consumption, memorability, wide viewing angle, and non-flickering display. Besides, a display panel with the bistable characteristic can continuously display previously written images. Thus, the power consumption of a bistable LCD is lower than that of a transmissive LCD. Thereby, the application of bistable LCD has been gradually recognized.

With different amplitudes and durations of the voltage pulse, bistable liquid crystals either reflect or transmit light. Thus, the grayscales of bistable liquid crystals can be controlled through amplitude modulation (AM) or pulse width modulation (PWM). When a bistable liquid crystal is driven through AM, the grayscale (i.e., reflectance) of the bistable liquid crystal is adjusted by using the pulse height. Thus, a digital-to-analog converter (DAC) needs to be adopted for converting digital display data into an analog voltage, and the DAC needs to receive reference voltages of different levels in order to convert the digital display data. The reference voltages of different levels can be generated through the voltage division effect of serially connected resistors. In the DAC, a multiplexer composed of a plurality of transistors selects one of the reference voltages according to the digital display data and outputs the voltage corresponding to the digital display data. However, the circuit complexity and chip area of the DAC increase exponentially along with the increase in the bit number of the display data. As a result, the hardware cost of the DAC also presents an exponential increase.

When a bistable liquid crystal is driven through PWM, the grayscale (i.e., reflectance) of the bistable liquid crystal is adjusted by using the pulse width. In this case, a DAC is still adopted to convert digital display data into a corresponding voltage, and the voltage is compared with a sawtooth wave signal to determine the pulse width. However, such a technique still requires a DAC, and when the bit number of the display data increases, the circuit complexity and chip area of the DAC increase exponentially, and accordingly the hardware cost of the DAC increase exponentially.

### SUMMARY OF THE INVENTION

Accordingly, the invention is directed to a bistable LCD with simplified data driving circuit.

The invention provides a bistable LCD including a display panel, a plurality of column data drivers, a plurality of row data drivers, and a phase signal generating circuit. The display panel has a plurality of pixels. The column data drivers are coupled to the display panel. The column data drivers receive a plurality of phase control signals of different phases, a first high driving voltage, and a first low driving voltage and respectively receive a display data. Each of the column data drivers selects one of the phase control signals according to the display data and alternately outputs the first high driving voltage and the first low driving voltage according to the selected phase control signal to form a column driving signal for the display panel. The row data drivers are coupled to the display panel. The row data drivers receive one of the phase control signals, a second high driving voltage, and a second low driving voltage. Each of the row data drivers alternately outputs the second high driving voltage and the second low driving voltage according to the received phase control signal to form a row driving signal for the display panel. The reflectance of each of the pixels is determined by the voltage difference between the corresponding row driving signal and the corresponding column driving signal. The phase signal generating circuit provides the phase control signals.

According to an embodiment of the invention, the phase signal generating circuit includes a plurality of shift registers and a logic unit. The shift registers respectively have an input terminal, a trigger terminal, a positive output terminal, a negative output terminal, and a reset terminal, where the reset terminals of the shift registers receive a reset signal, the trigger terminals of the shift registers receive a first clock signal, the positive output terminal of the i^{th} shift register is coupled to the input terminal of the (i+1)^{th} shift register, the input terminal of the first shift register is coupled to the negative output terminal of the last shift register, and the positive output terminals or the negative output terminals of the shift registers output the phase control signals. Herein i is a positive integer. The logic unit provides the first clock signal and receives a second clock signal and an enable signal, and when the enable signal is enabled, the logic unit outputs the second clock signal as the first clock signal. Besides, before the enable signal is enabled, the reset signal is enabled to reset the shift registers.

According to an embodiment of the invention, the phase signal generating circuit includes a plurality of voltage-controlled delay units, a phase detector, and a filtering circuit. The voltage-controlled delay units are serially connected with each other and receive a control voltage. The first voltage-controlled delay unit receives a third clock signal, signals at the input terminals or the output terminals of the voltage-controlled delay units are the phase control signals, and the output terminal of the last voltage-controlled delay unit provides a phase comparison signal. The phase detector receives the third clock signal and the phase comparison signal and outputs a phase adjustment signal according to the third clock signal and the phase comparison signal. The filtering circuit receives the phase adjustment signal and outputs the control voltage.

According to an embodiment of the invention, each of the column data drivers includes a first multiplexer and a second multiplexer. The first multiplexer has a plurality of first input terminals for receiving the phase control signals, a first control terminal for receiving the corresponding display data, and a first output terminal. The second multiplexer has a plurality of second input terminals for receiving the first high driving voltage and the first low driving voltage, a second control terminal coupled to the first output terminal for receiving the corresponding phase control signal, and a second output terminal for outputting the corresponding column driving signal.

According to an embodiment of the invention, the row data drivers respectively receive a row selection signal, and each of the column data drivers alternately outputs the second high driving voltage and the second low driving voltage according to the received phase control signal to form the column driving signal for the display panel when the corresponding row selection signal is enabled.

According to an embodiment of the invention, each of the row data drivers includes a first switch and a third multiplexer. The first switch has a first terminal for receiving one of the phase control signals, a control terminal for receiving the corresponding row selection signal, and a second terminal. The third multiplexer has a plurality of third input terminals for receiving the second high driving voltage and the second low driving voltage, a third control terminal coupled to the second terminal of the first switch, and a third output terminal for outputting the corresponding row driving signal.

According to an embodiment of the invention, the second high driving voltage is greater than the first high driving voltage, and the second low driving voltage is smaller than the first low driving voltage.

According to an embodiment of the invention, the difference between the first high driving voltage and the second high driving voltage is equal to a lowest grayscale voltage for driving a bistable liquid crystal to display a minimum grayscale value, the difference between the first low driving voltage and the second high driving voltage is equal to a highest grayscale voltage for driving a bistable liquid crystal to display a maximum grayscale value, the difference between the first low driving voltage and the second low driving voltage is equal to the lowest grayscale voltage, and the difference between the first high driving voltage and the second low driving voltage is equal to the highest grayscale voltage.

According to an embodiment of the invention, the difference between the first high driving voltage and a common voltage is smaller than a threshold voltage for driving a bistable liquid crystal, and the difference between the first low driving voltage and the common voltage is smaller than the threshold voltage.

According to an embodiment of the invention, the bistable LCD further includes a scan driver for providing the row selection signals.

According to an embodiment of the invention, each of the pixels receives the corresponding row selection signal, and when the corresponding row selection signal is enabled, the reflectance of the pixel is determined by the voltage difference between the corresponding row driving signal and the corresponding column driving signal.

According to an embodiment of the invention, during a grayscale writing period corresponding to each of the pixels, each of the column driving signals produces a plurality of first pulses, and each of the row driving signals produces a plurality of second pulses.

According to an embodiment of the invention, an average phase difference between the first pulses and the second pulses is determined by the corresponding display data.

According to an embodiment of the invention, a plurality of phase differences between the first pulses and the second pulses is completely the same.

According to an embodiment of the invention, a plurality of phase differences between the first pulses and the second pulses is at least partially the same.

As described above, in a bistable LCD provided by an embodiment of the invention, the root mean square (RMS) of the voltage difference received by each pixel is controlled through the phase differences between the column driving signals and the row driving signals. Because the data driving circuit is simplified and no digital-to-analog converter (DAC) is adopted, the hardware cost of the bistable LCD is reduced.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the relationship between the reflectance of bistable liquid crystals and the root mean square (RMS) of a voltage difference.

FIG. 2 is a system diagram of a bistable liquid crystal display (LCD) according to an embodiment of the invention.

FIGS. 3A-3E are diagrams respectively illustrating the driving waveforms of signals in the bistable LCD in FIG. 2 according to an embodiment of the invention.

FIG. 4A is a circuit diagram of a column data driver in FIG. 2 according to an embodiment of the invention.

FIG. 4B is a circuit diagram of a row data driver in FIG. 2 according to an embodiment of the invention.

FIG. 5A is a circuit diagram of a phase signal generating circuit in FIG. 2 according to an embodiment of the invention.

FIG. 5B and FIG. 5C are diagrams respectively illustrating the driving waveforms of signals in the phase signal generating circuit in FIG. 5A according to an embodiment of the invention.

FIG. 6 is a circuit diagram of the phase signal generating circuit in FIG. 2 according to another embodiment of the invention.

FIG. 7 is a system diagram of a bistable LCD according to another embodiment of the invention.

### DESCRIPTION OF THE EMBODIMENTS

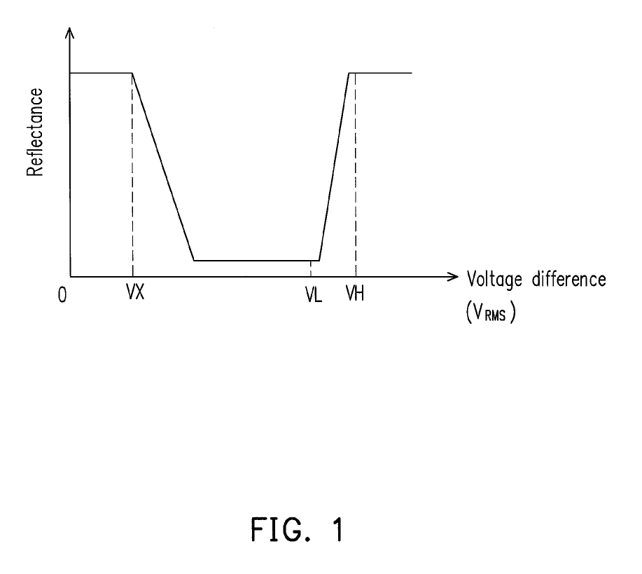

FIG. 1 is a diagram illustrating the relationship between the reflectance of bistable liquid crystals and the RMS of a voltage difference. Referring to FIG. 1, as indicated by experimental results, the reflectance of bistable liquid crystals is determined by the RMS of the voltage difference (for example, the voltage difference between the voltage of a row driving signal and the voltage of a column driving signal) received by each pixel. Thus, the reflectance of bistable liquid crystals (i.e., the grayscale value displayed by each pixel) can be adjusted by controlling the RMS of the voltage difference received by each pixel through adjustment of the pulse of the driving signal. In consideration of the response speed, the RMS (i.e., the grayscale controlling voltage) of the voltage difference received by each pixel can be selectivity set between the voltage VH and the voltage VL. To avoid any impact on the state of the bistable liquid crystals, the voltage difference received by those undriven pixels should be smaller than the voltage VX′.

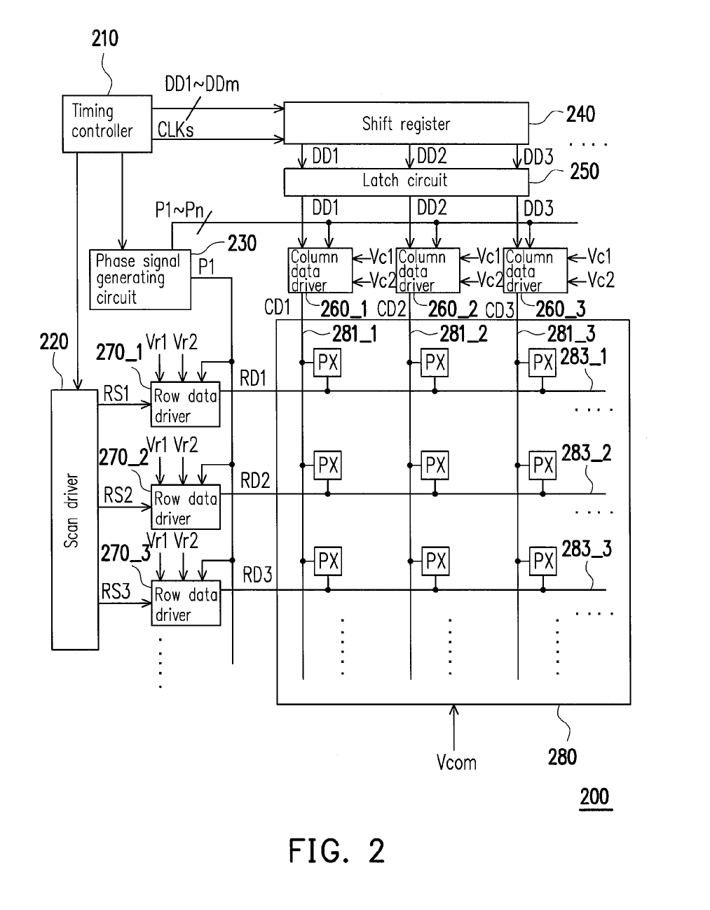

FIG. 2 is a system diagram of a bistable liquid crystal display (LCD) according to an embodiment of the invention. Referring to FIG. 2, in the present embodiment, the bistable LCD 200 includes a timing controller 210, a scan driver 220, a phase signal generating circuit 230, a shift register 240, a latch circuit 250, a plurality of column data drivers (such as 260_1-260_3), a plurality of row data drivers (such as 270_1-270_3), and a display panel 280.

The scan driver 220 is coupled to the timing controller 210 and controlled by the timing controller 210 to provide a plurality of row selection signals (such as RS1-RS3). These row selection signals (such as RS1-RS3) are sequentially enabled. The phase signal generating circuit 230 is coupled to the timing controller 210 and controlled by the timing controller 210 to provide a plurality of phase control signals P1-Pn of different phases, where n is a positive integer.

The shift register 240 is coupled to the timing controller 210, and which shifts a plurality of display data DD1-DDm provided by the timing controller 210 according to a clock signal CLKs provided by the timing controller 210, so as to output the display data (such as DD1-DD3) respectively corresponding to the column data drivers (such as 260_1-260_3), where m is a positive integer. The latch circuit 250 is coupled to the shift register 240, and which latches and outputs the display data (such as DD1-DD3) respectively corresponding to the column data drivers (such as 260_1-260_3). Herein the latch circuit 250 is controlled by the timing controller 210 to output the display data (such as DD1-DD3) respectively corresponding to the column data drivers (such as 260_1-260_3) at the same time. However, the invention is not limited thereto.

Each of the column data drivers (such as 260_1-260_3) is coupled to the phase signal generating circuit 230 to receive the phase control signals P1-Pn, is coupled to the latch circuit 250 to receive the corresponding display data among the display data (such as DD1-DD3), and receives a first high driving voltage Vc1 and a first low driving voltage Vc2. Each of the column data drivers (such as 260_1-260_3) selects one of the phase control signals P1-Pn according to the corresponding display data and alternately outputs the first high driving voltage Vc1 and the first low driving voltage Vc2 according to the selected phase control signal to form a column driving signal (such as CD1-CD3).

Each of the row data drivers (such as 270_1-270_3) is coupled to the phase signal generating circuit 230 to receive one of the phase control signals P1-Pn (here, take the phase control signal P1 for example), is coupled to the scan driver 220 to receive the corresponding row selection signal (such as RS1-RS3), and receives a second high driving voltage Vr1 and a second low driving voltage Vr2. Each of the row data drivers (such as 270_1-270_3) alternately outputs the second high driving voltage Vr1 and the second low driving voltage Vr2 according to the received phase control signal P1 to form a row driving signal (such as RD1-RD3) when the corresponding row selection signal is enabled. Contrarily, each of the row data drivers (such as 270_1-270_3) does not output any row driving signal or outputs a common voltage Vcom when the corresponding row selection signal is disabled.

The display panel 280 receives the common voltage Vcom. The display panel 280 has a plurality of first signal lines (such as 281_1-281_3), a plurality of second signal lines (such as 283_1-283_3), and a plurality of pixels PX. The first signal lines (such as 281_1-281_3) are respectively coupled to the column data drivers (such as 260_1-260_3) to receive the corresponding column driving signals (such as CD1-CD3). The second signal lines (such as 283_1-283_3) are respectively coupled to the row data drivers (such as 270_1-270_3) to receive the corresponding row driving signals (such as RD1-RD3). The pixels PX are respectively coupled to the first signal lines (such as 281_1-281_3) to receive the corresponding column driving signals (such as CD1-CD3) and are respectively coupled to the second signal lines (such as 283_1-283_3) to receive the corresponding row driving signals (such as RD1-RD3). Besides, each pixel PX is driven by the voltage difference between the corresponding row driving signal (such as RD1-RD3) and the corresponding column driving signal (such as CD1-CD3) so as to determine the reflectance thereof. In other words, the reflectance of each pixel PX is determined by the difference of the voltage difference between the corresponding row driving signal and the corresponding column driving signal and the common voltage Vcom.

In the present embodiment, all the pixels PX on the display panel 280 are passive pixels and are driven row by row, and the row driving signals (such as RD1-RD3) are respectively sent to all the pixels PX on the display panel 280. In order to prevent the state of the undriven pixels PX from being changed, the voltage difference between the second high driving voltage Vr1 and the common voltage Vcom is set to be smaller than the threshold voltage (for example, the voltage VX in FIG. 1) for driving bistable liquid crystals, and the voltage difference between the second low driving voltage Vr2 and the common voltage Vcom is set to be smaller than aforementioned threshold voltage.

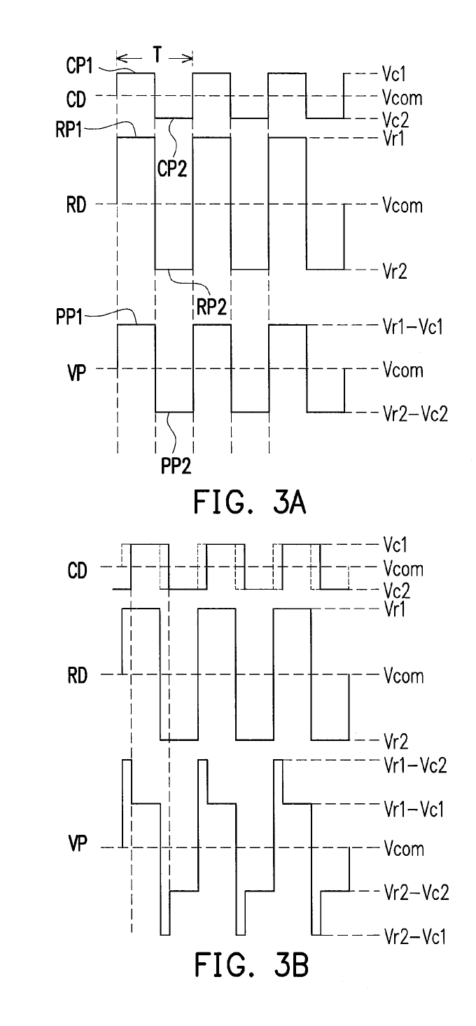

FIGS. 3A-3E are diagrams respectively illustrating the driving waveforms of signals in the bistable LCD in FIG. 2 according to an embodiment of the invention. Referring to FIGS. 3A-3E, in the present embodiment, the first high driving voltage Vc1 and the second high driving voltage Vr1 are set to be greater than the common voltage Vcom, the first low driving voltage Vc2 and the second low driving voltage Vr2 are set to be smaller than the common voltage Vcom, and it is assumed that the voltage difference between the first high driving voltage Vc1 and the common voltage Vcom is the same as the voltage difference between the first low driving voltage Vc2 and the common voltage Vcom, and the voltage difference between the second high driving voltage Vr1 and the common voltage Vcom is the same as the voltage difference between the second low driving voltage Vr2 and the common voltage Vcom. Besides, the second high driving voltage Vr1 is set to be greater than the first high driving voltage Vc1, and the second low driving voltage Vr2 is set to be smaller than the first low driving voltage Vc2.

In the present embodiment, the waveform CD represents the waveform of the column driving signals (such as CD1-CD3), the waveform RD represents the waveform of the row driving signals (such as RD1-RD3), and the waveform VP represents the waveform of the voltage difference received by each pixel PX. The phase difference between the dotted portions of the waveform CD in FIGS. 3B-3E and the row driving signal (such as RD1-RD3) is 0.

When the column driving signal (such as CD1-CD3) is the first high driving voltage Vc1 and the row driving signal (such as RD1-RD3) is the second high driving voltage Vr1, the voltage difference received by each pixel PX is Vr1-Vc1. When the column driving signal (such as CD1-CD3) is the first low driving voltage Vc2 and the row driving signal (such as RD1-RD3) is the second high driving voltage Vr1, the voltage difference received by each pixel PX is Vr1-Vc2. When the column driving signal (such as CD1-CD3) is the first high driving voltage Vc1 and the row driving signal (such as RD1-RD3) is the second low driving voltage Vr2, the voltage difference received by each pixel PX is Vc1-Vr2. When the column driving signal (such as CD1-CD3) is the first low driving voltage Vc2 and the row driving signal (such as RD1-RD3) is the second low driving voltage Vr2, the voltage difference received by each pixel PX is Vc2-Vr2.

In the embodiment illustrated in FIG. 3A, the phase difference between the column driving signal (such as CD1-CD3) and the corresponding row driving signal (such as RD1-RD3) is 0. Herein the period during which the column driving signal (such as CD1-CD3) is the first high driving voltage Vc1 completely overlaps the period during which the row driving signal (such as RD1-RD3) is the second high driving voltage Vr1, and the period during which the column driving signal (such as CD1-CD3) is the first low driving voltage Vc2 completely overlaps the period during which the row driving signal (such as RD1-RD3) is the second low driving voltage Vr2.

In the embodiment illustrated in FIG. 3B, the phase difference between the column driving signal (such as CD1-CD3) and the corresponding row driving signal (such as RD1-RD3) is ¼π (i.e., 45°). Herein the period during which the column driving signal (such as CD1-CD3) is the first high driving voltage Vc1 and the period during which the row driving signal (such as RD1-RD3) is the second high driving voltage Vr1 have a time difference T/8 (equivalent to delaying the column driving signal for a time T/8), and the period during which the column driving signal (such as CD1-CD3) is the first low driving voltage Vc2 and the period during which the row driving signal (such as RD1-RD3) is the second low driving voltage Vr2 have a time difference T/8, where T is the time length of a cycle of the column driving signal (such as CD1-CD3) or the row driving signal (such as RD1-RD3).

In the embodiment illustrated in FIG. 3C, the phase difference between the column driving signal (such as CD1-CD3) and the corresponding row driving signal (such as RD1-RD3) is ½π (i.e., 90°). Herein the period during which the column driving signal (such as CD1-CD3) is the first high driving voltage Vc1 and the period during which the row driving signal (such as RD1-RD3) is the second high driving voltage Vr1 have a time difference T/4 (equivalent to delaying the column driving signal for a time T/4), and the period during which the column driving signal (such as CD1-CD3) is the first low driving voltage Vc2 and the period during which the row driving signal (such as RD1-RD3) is the second low driving voltage Vr2 have a time difference T/4.

In the embodiment illustrated in FIG. 3D, the phase difference between the column driving signal (such as CD1-CD3) and the corresponding row driving signal (such as RD1-RD3) is ¾π (i.e., 135°). Herein the period during which the column driving signal (such as CD1-CD3) is the first high driving voltage Vc1 and the period during which the row driving signal (such as RD1-RD3) is the second high driving voltage Vr1 have a time difference 3T/8 (equivalent to delaying the column driving signal for a time 3T/8), and the period during which the column driving signal (such as CD1-CD3) is the first low driving voltage Vc2 and the period during which the row driving signal (such as RD1-RD3) is the second low driving voltage Vr2 have a time difference 3T/8.

In the embodiment illustrated in FIG. 3E, the phase difference between the column driving signal (such as CD1-CD3) and the corresponding row driving signal (such as RD1-RD3) is π (i.e., 180°). Herein the period during which the column driving signal (such as CD1-CD3) is the first high driving voltage Vc1 and the period during which the row driving signal (such as RD1-RD3) is the second high driving voltage Vr1 have a time difference T/2, and the period during which the column driving signal (such as CD1-CD3) is the first low driving voltage Vc2 and the period during which the row driving signal (such as RD1-RD3) is the second low driving voltage Vr2 have a time difference T/2.

As shown in FIGS. 3A-3B, a greater phase difference between the column driving signal (such as CD1-CD3) and the corresponding row driving signal (such as RD1-RD3) leads to a greater RMS of the voltage difference received by each pixel PX, and the RMS reaches the maximum value when the phase difference between the column driving signal (such as CD1-CD3) and the corresponding row driving signal (such as RD1-RD3) is π. Herein it is assumed that the phase adjustment rate is 100% when the phase difference between the column driving signal (such as CD1-CD3) and the corresponding row driving signal (such as RD1-RD3) is π. Accordingly, the relationship of the time difference between the column driving signal (such as CD1-CD3) and the corresponding row driving signal (such as RD1-RD3) to the phase adjustment rate can be expressed as:

$$D = 2 \frac{td}{T} \times 100 \%$$

In foregoing expression, D is the phase adjustment rate, td is the time difference between the column driving signal (such as CD1-CD3) and the corresponding row driving signal (such as RD1-RD3), and T is the time length of a cycle of the column driving signal (such as CD1-CD3) or the row driving signal (such as RD1-RD3).

As mentioned in the description related to FIG. 1, in consideration of the response speed, the RMS (i.e., the grayscale controlling voltage) of the voltage difference received by each pixel PX can be selectivity located between the voltage VH and the voltage VL. Thus, in the present embodiment, the voltage difference between the first high driving voltage Vc1 and the second high driving voltage Vr1 and the voltage difference between the first low driving voltage Vc2 and the second low driving voltage Vr2 can be set to be equal to the lowest grayscale voltage (for example, the voltage VL in FIG. 1) for driving bistable liquid crystals to display the minimum grayscale value (i.e., the minimum reflectance), and the voltage difference between the first low driving voltage Vc2 and the second high driving voltage Vr1 and the voltage difference between the first high driving voltage Vc1 and the second low driving voltage Vr2 can be set to be equal to the highest grayscale voltage (for example, the voltage VH in FIG. 1) for driving bistable liquid crystals to display the maximum grayscale value (i.e., the maximum reflectance). Thus, the relationship between the RMS of the voltage difference received by each pixel PX and the phase adjustment rate D can be expressed as:

$$\begin{matrix}{V}_{RMS} = \sqrt{\frac{1}{T} {\int }_{0}^{T} {v}^{2} ( t ) d t} \\ = \sqrt{{DV}_{H}^{2} + ( 1 - D ) {V}_{L}^{2}}\end{matrix}$$

In foregoing expression, V_{RMS} is the RMS of the voltage difference received by each pixel PX, ν is the voltage difference received by each pixel PX, D is the phase adjustment rate (between 0 and 100%), V_{H} is the highest grayscale voltage, and V_{L} is the lowest grayscale voltage.

Thereby, in the present embodiment, by changing the delay time of the column driving signal (such as CD1-CD3), the phase difference between the column driving signal (such as CD1-CD3) and the corresponding row driving signal (such as RD1-RD3) can be adjusted, so that the RMS of the voltage difference received by each pixel PX can be changed to set the reflectance (i.e., grayscale value) of the pixel PX.

Generally, bistable liquid crystals need to be driven by continuous pulses. Namely, during a grayscale writing period corresponding to each pixel PX, the voltage difference received by the pixel PX produces positive pulses and negative pulses (for example, the positive pulse PP1 and the negative pulse PP2 of the waveform VP in FIG. 3A). In other words, during the grayscale writing period corresponding to each pixel PX, each column driving signal produces a plurality of first pulses (for example, the pulses CP1 and CP2), and each row driving signal produces a plurality of second pulses (for example, the pulses RP1 and RP2).

In the present embodiment, the column data drivers (such as 260_1-260_3) respectively select one of the phase control signals P1-Pn according to the corresponding display data (such as DD1-DD3), so as to control the phases of the first pulses (such as CP1 and CP2) of the column driving signals (such as CD1-CD3). Thus, the average phase differences between the first pulses (such as CP1 and CP2) and the second pulses (such as RP1 and RP2) are determined by the corresponding display data (such as DD1-DD3).

As shown in FIGS. 3A-3E, in an embodiment of the invention, a plurality of phase differences (corresponding to the phase adjustment rate D) between the first pulses (such as CP1 and CP2) and the second pulses (such as RP1 and RP2) are completely the same. However, in other embodiments of the invention, the phase differences between the first pulses (such as CP1 and CP2) and the second pulses (such as RP1 and RP2) may be partially the same. Namely, the phase differences between the first pulses (such as CP1 and CP2) and the second pulses (such as RP1 and RP2) may not be completely the same.

Following table 1 is a phase difference distribution table according to an embodiment of the invention. Herein it is assumed that both the number of the first pulses (such as CP1 and CP2) and the number of the second pulses (such as RP1 and RP2) are 4, and the phase adjustment rates D1-D4 are respectively the phase adjustment rate D between each of the first pulses (such as CP1 and CP2) and the corresponding second pulses (such as RP1 and RP2). As shown in table 1, the resolution of the average phase difference (i.e., the average phase adjustment rate Davg) of the first pulses (such as CP1 and CP2) and the second pulses (such as RP1 and RP2) can be higher.

TABLE 1

| Davg (%) | D1 (%) | D2 (%) | D3 (%) | D4 (%) |
|---|---|---|---|---|
| 0 | 0 | 0 | 0 | 0 |
| 6.25 | 0 | 0 | 0 | 25 |
| 12.5 | 0 | 0 | 25 | 25 |
| 18.75 | 0 | 25 | 25 | 25 |
| 25 | 25 | 25 | 25 | 25 |
| 31.25 | 25 | 25 | 25 | 50 |
| 37.5 | 25 | 25 | 50 | 50 |
| 43.75 | 25 | 50 | 50 | 50 |
| 50 | 50 | 50 | 50 | 50 |
| 56.25 | 50 | 50 | 50 | 75 |
| 62.5 | 50 | 50 | 75 | 75 |
| 68.75 | 50 | 75 | 75 | 75 |
| 75 | 75 | 75 | 75 | 75 |
| 81.25 | 75 | 75 | 75 | 100 |
| 87.5 | 75 | 75 | 100 | 100 |
| 93.75 | 75 | 100 | 100 | 100 |
| 100 | 100 | 100 | 100 | 100 |

In an actual application, the relationship between the RMS of the voltage difference received by each pixel PX and the phase adjustment rate D is approximately (but not completely) linear. Thus, to achieve a higher resolution, a look-up table is established in the timing controller 210, and the display data DD1-DDm are pre-corrected into corresponding phase adjustment rates D through table lookup according to the RMSs of the corresponding voltage differences.

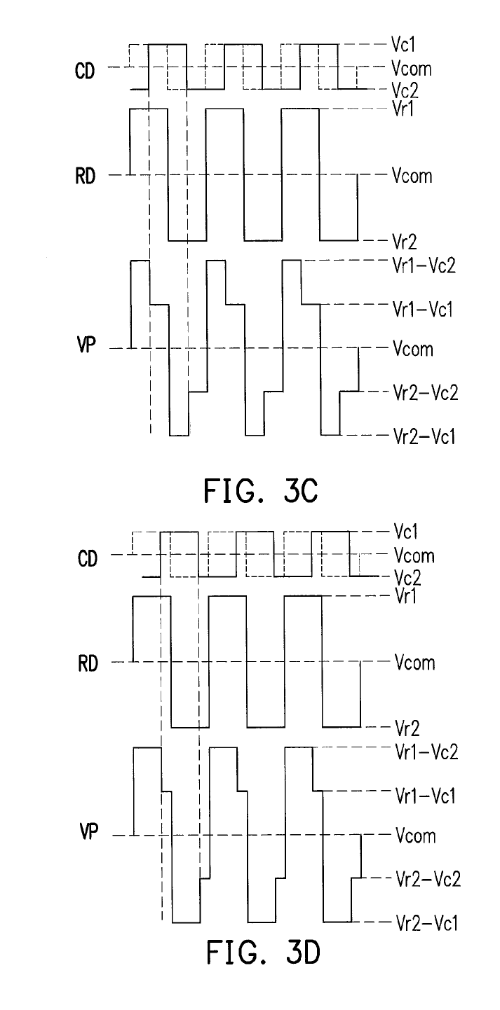

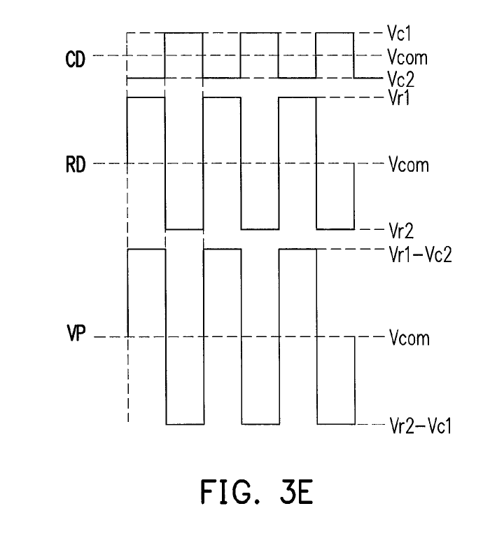

FIG. 4A is a circuit diagram of a column data driver in FIG. 2 according to an embodiment of the invention. Referring to FIG. 2 and FIG. 4A, in the present embodiment, each column data driver 260 includes a first multiplexer 410 and a second multiplexer 420. The first multiplexer 410 has a plurality of first input terminals for receiving the phase control signals P1-Pn, a first control terminal for receiving the corresponding display data DDi (such as DD1-DDm), and a first output terminal, where is a positive integer. The second multiplexer 420 has a plurality of second input terminals for receiving the first high driving voltage Vc1 and the first low driving voltage Vc2, a second control terminal coupled to the first output terminal of the first multiplexer 410 for receiving the corresponding one of the phase control signals (such as P1-Pn), and a second output terminal for outputting a corresponding column driving signal CDi.

To be specific, the first multiplexer 410 outputs one of the phase control signals P1-Pn according to the corresponding display data DDi, and the second multiplexer 420 alternately outputs the first high driving voltage Vc1 and the first low driving voltage Vc2 according to the phase control signal output by the first multiplexer 410 to form the corresponding column driving signal CDi (such as CD1-CD3). For example, the first high driving voltage Vc1 is output when the corresponding phase control signal is at a high voltage level, and the first low driving voltage Vc2 is output when the corresponding phase control signal is at a low voltage level.

FIG. 4B is a circuit diagram of a row data driver in FIG. 2 according to an embodiment of the invention. Referring to FIG. 2 and FIG. 4B, in the present embodiment, each row data driver 270 includes a first switch SW1 and a third multiplexer 430. The first switch SW1 has a first terminal for receiving one of the phase control signals P1-Pn (here, take the phase control signal P1 for example), a control terminal for receiving the corresponding row selection signal RSi (such as RS1-RS3), and a second terminal. The third multiplexer 430 has a plurality of third input terminals for receiving the second high driving voltage Vr1 and the second low driving voltage Vr2, a third control terminal coupled to the second terminal of the first switch SW1 for receiving the phase control signal P1, and a third output terminal for outputting the corresponding row driving signal RDi (such as RD1-RD3).

To be specific, when the first switch SW1 is turned on according to the corresponding row selection signal RSi, the phase control signal P1 is sent to the third control terminal of the third multiplexer 430, and the third multiplexer 430 alternately outputs the second high driving voltage Vr1 and the second low driving voltage Vr2 according to the phase control signal P1 to form the corresponding row driving signal RDi (such as RD1-RD3). For example, the second high driving voltage Vr1 is output when the phase control signal P1 is at a high voltage level, and the second low driving voltage Vr2 is output when the phase control signal P1 is at a low voltage level. When the third multiplexer 430 does not receive the phase control signal P1, the third output terminal of the third multiplexer 430 is floating or outputs the common voltage Vcom.

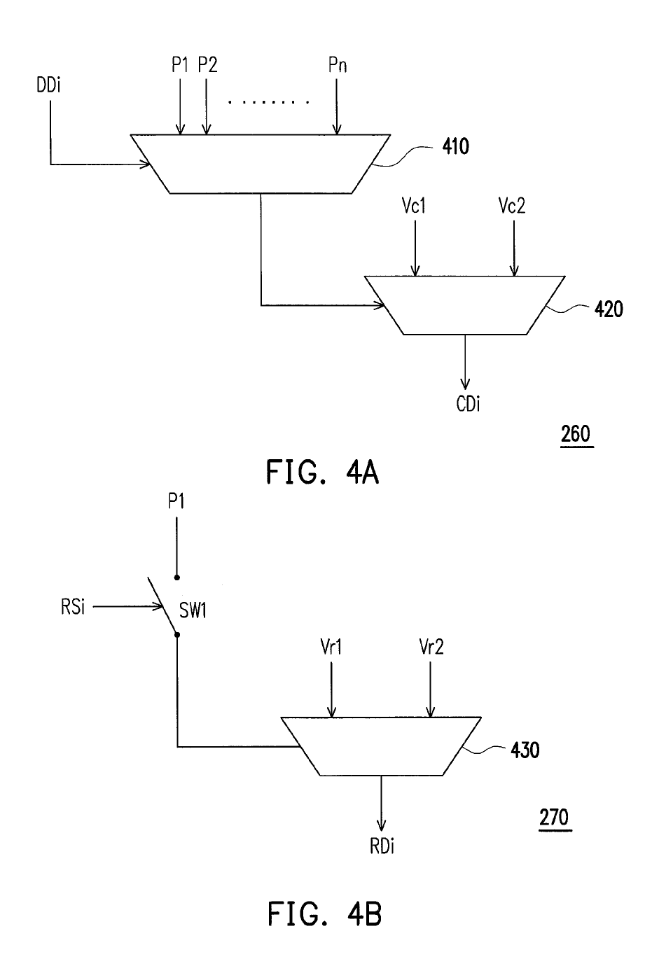

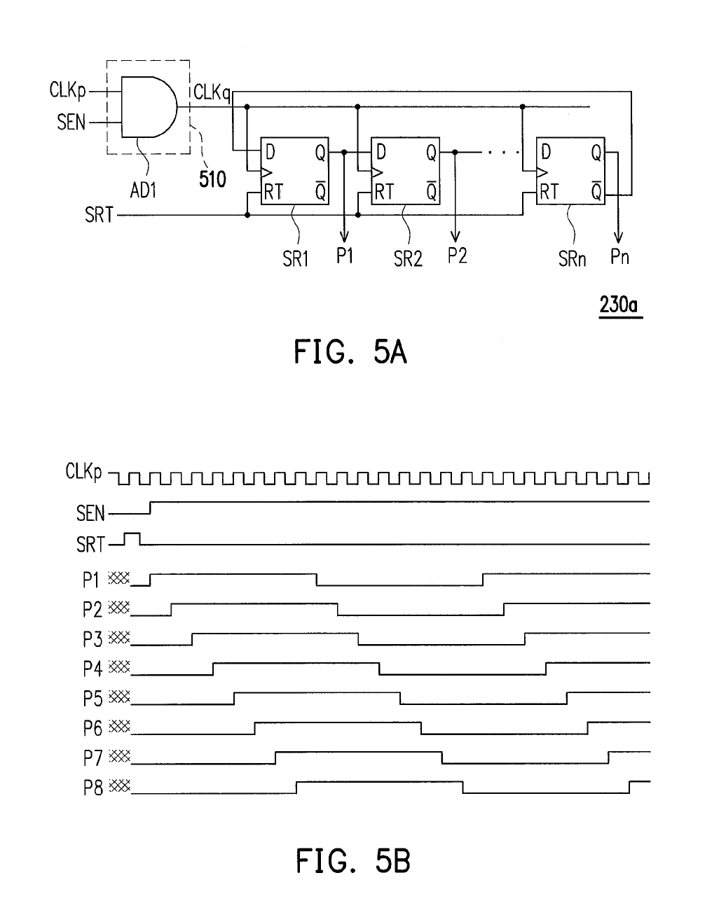

FIG. 5A is a circuit diagram of a phase signal generating circuit in FIG. 2 according to an embodiment of the invention. Referring to FIG. 2 and FIG. 5A, in the present embodiment, the phase signal generating circuit 230a includes a logic unit 510 and a plurality of shift registers SR1-SRn. Herein the logic unit 510 may include an AND gate AD1. The input terminals of the AND gate AD1 respectively receive a clock signal CLKp (corresponding to the second clock signal) and an enable signal SEN. When the enable signal SEN is enabled, the output terminal of the AND gate AD1 outputs the clock signal CLKp as a clock signal CLKq (corresponding to the first clock signal) to the shift registers SR1-SRn. Herein the clock signal CLKp and the enable signal SEN may be provided by the timing controller 210.

Each of the shift registers SR1-SRn has an input terminal D, a trigger terminal, a positive output terminal Q, a negative output terminal Q̅, and a reset terminal RT. The trigger terminals of the shift registers SR1-SRn receive the clock signal CLKq from the AND gate AD1. The reset terminals RT of the shift registers SR1-SRn receive a reset signal SRT. Herein the reset signal SRT may be provided by the timing controller 210.

The input terminal D of the shift register SR1 is coupled to the negative output terminal Q̅ of the shift register SRn, the positive output terminal Q of the shift register SR1 outputs the phase control signal P1 and is coupled to the input terminal D of the shift register SR2, the positive output terminal Q of the shift register SR2 outputs the phase control signal P2 and is coupled to the input terminal D of the shift register SR3, and so on.

In the present embodiment, the phase control signals P1-Pn are provided by the positive output terminals Q of the shift registers SR1-SRn. However, in other embodiments, the phase control signals P1-Pn may also be provided by the negative output terminals Q̅ of the shift registers SR1-SRn.

FIG. 5B and FIG. 5C are diagrams respectively illustrating the driving waveforms of signals in the phase signal generating circuit in FIG. 5A according to an embodiment of the invention. Referring to FIGS. 5A-5C, the present embodiment will be described by assuming that there are 8 phase control signals P1-P8. Before the enable signal SEN is enabled, the reset signal SRT is enabled to reset the shift registers SR1-SRn (i.e., the positive output terminals Q of the shift registers SR1-SRn are at a low voltage level, and the negative output terminals Q̅ of the shift registers SR1-SRn are at a high voltage level). When the enable signal SEN is enabled, the clock signal CLKq is the same as the clock signal CLKp so that the shift registers SR1-SRn are triggered to form the phase control signals P1-P8 of different phases. Thereafter, when the enable signal SEN is disabled, the clock signal CLKq is at a low voltage level, so that the shift registers SR1-SRn are not triggered (i.e., the phase signal generating circuit 230a stops working).

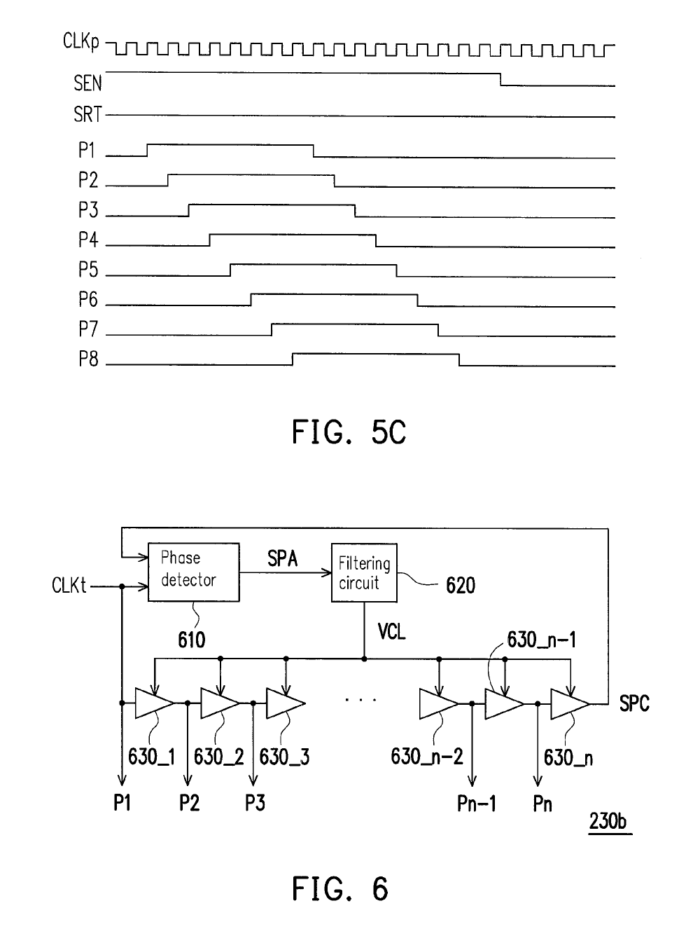

FIG. 6 is a circuit diagram of the phase signal generating circuit in FIG. 2 according to another embodiment of the invention. Referring to FIG. 2 and FIG. 6, in the present embodiment, the phase signal generating circuit 230b includes a phase detector 610, a filtering circuit 620, and a plurality of voltage-controlled delay units 630_1-630_{—}n. The voltage-controlled delay units 630_1-630_{—}n are serially connected with each other and receive a control voltage VCL. Herein the voltage-controlled delay unit 630_1 receives a clock signal CLKt (corresponding to the third clock signal), signals at the input terminals of the voltage-controlled delay units 630_1-630_{—}n are served as the phase control signals P1-Pn, and the output terminal of the voltage-controlled delay unit 630_{—}n provides a phase comparison signal SPC. The phase detector 610 receives the clock signal CLKt and the phase comparison signal SPC, compares the clock signal CLKt with the phase comparison signal SPC, and outputs a phase adjustment signal SPA according to the comparison result. The filtering circuit 620 is coupled to the phase detector 610. The filtering circuit 620 receives the phase adjustment signal SPA and outputs the control voltage VCL according to the phase adjustment signal SPA.

In the present embodiment, signals at the input terminals of the voltage-controlled delay units 630_1-630_{—}n are served as the phase control signals P1-Pn. However, in other embodiments, signals at the output terminals of the voltage-controlled delay units 630_1-630_{—}n may also be served as the phase control signals P1-Pn.

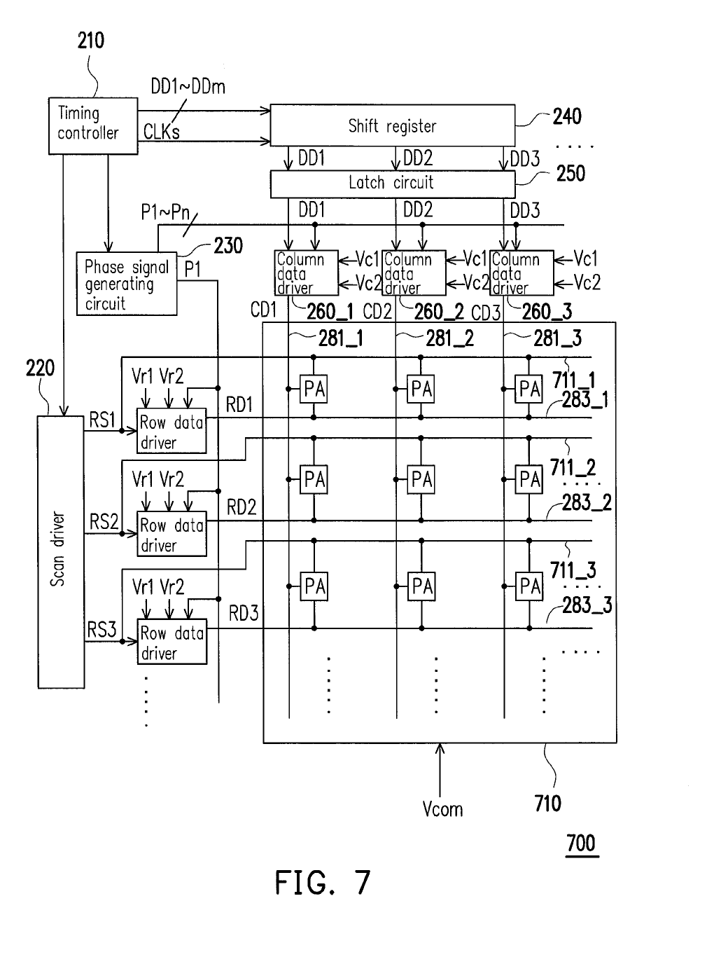

FIG. 7 is a system diagram of a bistable LCD according to another embodiment of the invention. Referring to FIG. 1 and FIG. 7, the bistable LCD 700 is approximately the same as the bistable LCD 100 (in which the same or similar elements are marked with the same or similar reference numerals), and the difference falls on the display panel 710. In the present embodiment, the display panel 710 further includes a plurality of third signal lines (such as 711_1-711_3), and the pixels PA on the display panel 710 are active pixels. The third signal lines (such as 711_1-711_3) are coupled to the scan driver 220 to respectively receive the corresponding row selection signals (such as RS1-RS3). The pixel PA is coupled to the corresponding third signal line (such as 711_1-711_3) to receive the corresponding row selection signal (such as RS1-RS3), and the pixel PA are turned on according to the corresponding row selection signal (such as RS1-RS3).

Thereby, the pixel PA receive the corresponding column driving signal (such as CD1-CD3) and row driving signal (such as RD1-RD3) when the corresponding row selection signal (such as RS1-RS3) are enabled, and the reflectance of the pixel PA is determined by the voltage differences between the corresponding row driving signal (such as RD1-RD3) and the corresponding column driving signal (such as CD1-CD3). Besides, because the pixels PA are active pixels, the first high driving voltage Vr1 and the first low driving voltage Vr2 can be set to any values.

As described above, in a bistable LCD provided by an embodiment of the invention, the RMS of the voltage difference received by each pixel is controlled through the phase differences between column driving signals and row driving signals, so that the data driving circuit can be simplified and the hardware cost of the bistable LCD can be reduced.

What is claimed is:

1. A bistable liquid crystal display (LCD), comprising:
a display panel, having a plurality of pixels;
a plurality of column data drivers, coupled to the display panel, receiving a plurality of phase control signals of different phases, a first high driving voltage, and a first low driving voltage, and respectively receiving a display data, wherein each of the column data drivers selects one of the phase control signals according to the display data and alternately outputs the first high driving voltage and the first low driving voltage according to the selected phase control signal to form a column driving signal for the display panel;
a plurality of row data drivers, coupled to the display panel, receiving one of the phase control signals, a second high driving voltage, and a second low driving voltage, wherein each of the row data drivers alternately outputs the second high driving voltage and the second low driving voltage according to the received phase control signal to form a row driving signal for the display panel; and
a phase signal generating circuit, providing the phase control signals;
wherein a reflectance of each of the pixels is determined by a voltage difference between the corresponding row driving signal and the corresponding column driving signal.

2. The bistable LCD according to claim 1, wherein the phase signal generating circuit comprises:
a plurality of shift registers, respectively having an input terminal, a trigger terminal, a positive output terminal, a negative output terminal, and a reset terminal, wherein the reset terminals receive a reset signal, the trigger terminals of the shift registers receive a first clock signal, the positive output terminal of the i^{th} shift register is coupled to the input terminal of the (i+1)^{th} shift register, the input terminal of the first shift register is coupled to the negative output terminal of the last shift register, and the positive output terminals or the negative output terminals of the shift registers output the phase control signals, wherein i is a positive integer; and
a logic unit, providing the first clock signal, and receiving a second clock signal and an enable signal, wherein when the enable signal is enabled, the logic unit outputs the second clock signal as the first clock signal;
wherein before the enable signal is enabled, the reset signal is enabled to reset the shift registers.

3. The bistable LCD according to claim 1, wherein the phase signal generating circuit comprises:
a plurality of voltage-controlled delay units, serially connected with each other, and receiving a control voltage, wherein the first voltage-controlled delay unit receives a third clock signal, signals at input terminals or output terminals of the voltage-controlled delay units are the phase control signals, and the output terminal of the last voltage-controlled delay unit provides a phase comparison signal;
a phase detector, receiving the third clock signal and the phase comparison signal, and outputting a phase adjustment signal according to the third clock signal and the phase comparison signal; and
a filtering circuit, receiving the phase adjustment signal, and outputting the control voltage.

4. The bistable LCD according to claim 1, wherein each of the column data drivers comprises:
a first multiplexer, having a plurality of first input terminals for receiving the phase control signals, a first control terminal for receiving the corresponding display data, and a first output terminal; and
a second multiplexer, having a plurality of second input terminals for receiving the first high driving voltage and the first low driving voltage, a second control terminal coupled to the first output terminal for receiving the corresponding phase control signal, and a second output terminal for outputting the corresponding column driving signal.

5. The bistable LCD according to claim 1, wherein the row data drivers respectively receive a row selection signal, and each of the column data drivers alternately outputs the second high driving voltage and the second low driving voltage according to the received phase control signal to form the column driving signal for the display panel when the corresponding row selection signal is enabled

6. The bistable LCD according to claim 5, wherein each of the row data drivers comprises:
a first switch, having a first terminal for receiving one of the phase control signals, a control terminal for receiving the corresponding row selection signal, and a second terminal; and
a third multiplexer, having a plurality of third input terminals for receiving the second high driving voltage and the second low driving voltage, a third control terminal coupled to the second terminal of the first switch, and a third output terminal for outputting the corresponding row driving signal.

7. The bistable LCD according to claim 1, wherein the second high driving voltage is greater than the first high driving voltage, and the second low driving voltage is smaller than the first low driving voltage.

8. The bistable LCD according to claim 1, wherein a voltage difference between the first high driving voltage and the second high driving voltage is equal to a lowest grayscale voltage for driving a bistable liquid crystal to display a minimum grayscale value, a voltage difference between the first low driving voltage and the second high driving voltage is equal to a highest grayscale voltage for driving a bistable liquid crystal to display a maximum grayscale value, a voltage difference between the first low driving voltage and the second low driving voltage is equal to the lowest grayscale voltage, and a voltage difference between the first high driving voltage and the second low driving voltage is equal to the highest grayscale voltage.

9. The bistable LCD according to claim 1, wherein a voltage difference between the first high driving voltage and a common voltage is smaller than a threshold voltage for driving a bistable liquid crystal, and a voltage difference between the first low driving voltage and the common voltage is smaller than the threshold voltage.

10. The bistable LCD according to claim 1 further comprising a scan driver for providing a plurality of row selection signals.

11. The bistable LCD according to claim 10, wherein each of the pixels receives the corresponding row selection signal, and when the corresponding row selection signal is enabled, the reflectance of the pixel is determined according to the voltage difference between the corresponding row driving signal and the corresponding column driving signal.

12. The bistable LCD according to claim 1, wherein during a grayscale writing period corresponding to each of the pixels, each of the column driving signals produces a plurality of first pulses, and each of the row driving signals produces a plurality of second pulses.

13. The bistable LCD according to claim 12, wherein an average phase difference between the first pulses and the second pulses is determined by the corresponding display data.

14. The bistable LCD according to claim 13, wherein a plurality of phase differences between the first pulses and the second pulses is completely the same.

15. The bistable LCD according to claim 13, wherein a plurality of phase differences between the first pulses and the second pulses is at least partially the same.
